(19) United States
(12) Patent Application Publication
(10) Pub. No.: US 2004/0238103 A1
(43) Pub. Date: Dec. 2, 2004

(54) Method of producing seamless elastic trim

(75) Inventor: Carlos Alberto Cano, Estado De Mexico (MX)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: SARA LEE CORPORATION

(21) Appl. No.: 10/452,779

(22) Filed: May 30, 2003

(51) Int. Cl. B32B 31/00

(52) U.S. Cl. 156/155; 156/93; 156/176; 156/204

(57) ABSTRACT

A method of forming a garment trim is provided. The method includes folding a peripheral edge of a fabric to a selected position to form a cavity, inserting a binding in the cavity, securing the binding in the cavity and the peripheral edge in the selected position with a seam, and exposing the fabric to at least one condition sufficient to cause the binding to bond to the cavity and to dissipate the seam.

### BACKGROUND OF THE INVENTION

1. Field of the Invention

The present invention relates to methods of producing garments. More particularly, the present invention relates to methods of producing seamless, elastic trim for garments.

2. Description of Related Art

A garment can include an intimate apparel item such as, for example, a brassiere, a pair of underwear, and a pair of panties. Such intimate apparel is worn directly next to the skin. Thus, it can provide particular challenges with respect to maximizing the user's comfort while wearing the garment.

Many intimate apparel garments include a trim or edging (hereinafter “trim”) formed at the periphery of the garment. The trim provides one or more benefits to the garment. For example, the trim can mitigate unraveling of the garment at the periphery. Further, the trim can be used to provide elastic properties to the garment.

The trim can be a separate piece that is secured to the garment. Alternately, the trim can be a portion of the garment that has been folded over an elastic band and the secured again to the main portion of the garment. The folded trim has commonly been secured to the garment by a line of stitching or a seam. However, this seam defines an area of discontinuity in the garment, which can be aesthetically and/or physically displeasing.

Accordingly, there is a desire for garments that have the benefits available from prior trims, but without one or more of the aforementioned drawbacks and deficiencies of the prior trims.

### SUMMARY OF THE INVENTION

It is an object of the present invention to provide a method of providing a seamless trim to a garment.

It is another object to provide a method of forming an elastic, seamless trim.

It is another object to provide a reliable method of forming an elastic, seamless trim.

These and other objects and advantages of the present invention are provided by a method of forming a garment trim. The method includes folding a peripheral edge of a fabric to a selected position to form a cavity; inserting a binding in the cavity; securing the binding in the cavity and the peripheral edge in the selected position with a seam; and exposing the fabric to at least one condition sufficient to cause the binding to bond to the cavity and the seam to dissipate.

These and other objects and advantages of the present invention are provided by a method including folding a peripheral edge of the fabric to a selected position, with the selected position being a fold over a binding to define a curved edge; maintaining the peripheral edge in the selected position with a seam; applying heat and pressure to the trim to cause the binding to maintain the peripheral edge in the selected position; and applying a selected process condition to the trim to cause the seam to dissipate.

Further, the present invention provides a method including applying a binding to a first side of the fabric at a peripheral edge of the fabric, with the binding having heat activatable adhesive properties and elastic properties; folding the peripheral edge over the binding to form a curved edge; sewing the peripheral edge and the binding with a seam having heat dissipatable properties; and activating the heat activatable adhesive properties of the binding and the heat dissipatable properties of the seam so as to bond the binding to the fabric and to dissipate the seam.

Still further, the present invention provides a method including applying a binding to a first side of the fabric at a peripheral edge of the fabric, with the binding having heat activatable adhesive properties and elastic properties; folding the peripheral edge over the binding to form a curved edge; sewing the peripheral edge and the binding with a seam having solvent dissipatable properties, activating the heat activatable adhesive properties of the binding to bond the binding to the fabric, and activating the solvent dissipatable properties of the seam to dissipate the seam.

The above-described and other features and advantages of the present invention will be appreciated and understood by those skilled in the art from the following detailed description, drawings, and appended claims.

### BRIEF DESCRIPTION OF THE DRAWINGS

FIG. 1 is a perspective view of an exemplary embodiment of a garment blank for use with the method of the present invention;

FIG. 2 is a partial sectional view of the peripheral edge of the blank of FIG. 1; and

FIGS. 3 through 6 illustrate an exemplary embodiment of a method for providing a seamless trim to the peripheral edge of FIG. 2.

### DETAILED DESCRIPTION OF THE INVENTION

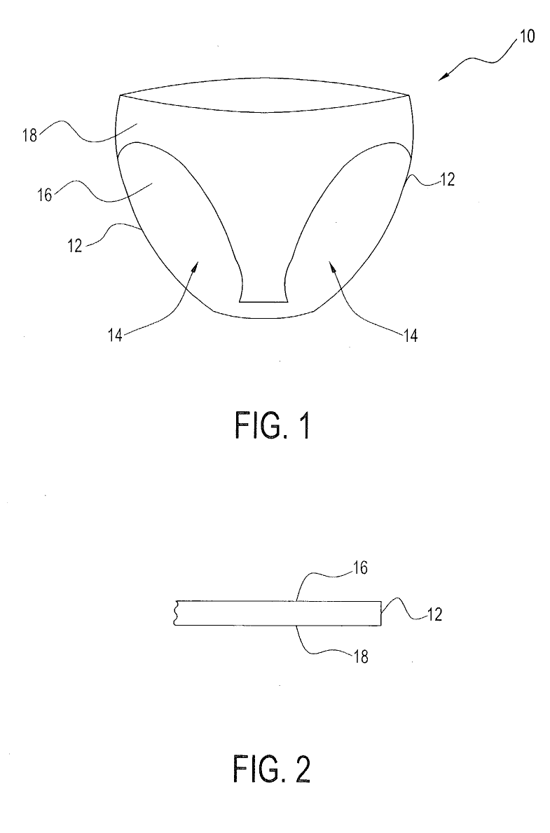

Referring to the drawings and in particular to FIGS. 1 and 2, an exemplary embodiment of a garment blank generally represented by reference numeral 10 is illustrated. Blank 10 has one or more peripheral edges 12 defined therein. For purposes of clarity, blank 10 is illustrated for use as a garment, particularly, a panty where peripheral edges 12 define a set of leg holes 14.

Blank 10 has a first side 16 and a second side 18. In the exemplary embodiment, first side 16 faces the skin of the wearer, while second side 18 faces away from the wearer. Of course, it is contemplated for first side 16 to face away from the wearer and second side 18 to face the skin of the wearer.

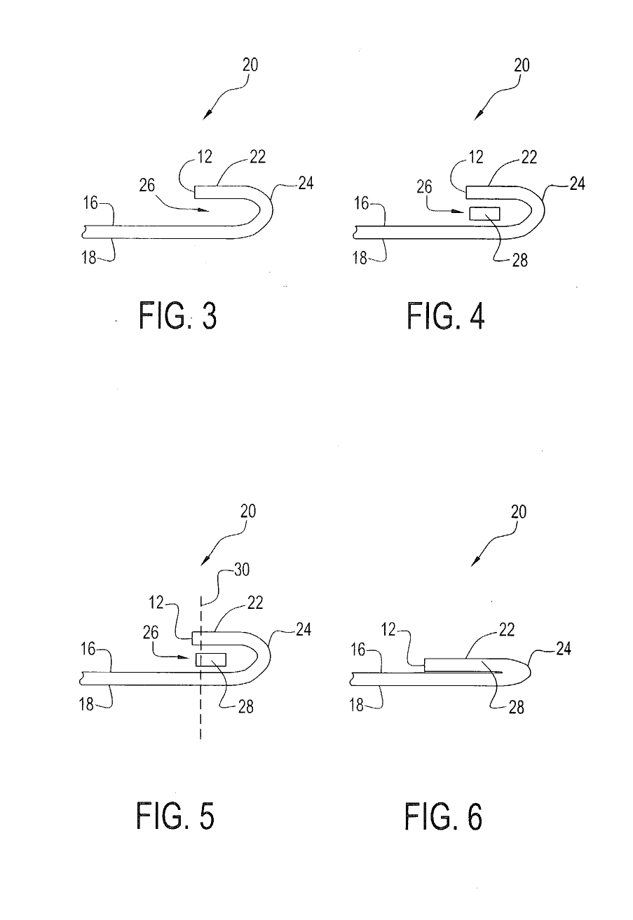

A method 20 of providing edges 12 with a seamless trim 22 is illustrated with simultaneous reference to FIGS. 3 through 6. As used herein, the term “trim” is a portion of blank 10 that has been folded over and secured to the blank. Thus, the fold of trim 22 moves edge 12 internal to blank 10 and provides a curved edge 24 to blank 10.

During method 20, edge 12 is folded toward first side 16 to form curved edge 24 facing outward of blank 10 and a cavity 26 facing inward of the blank. Before or simultaneous to the formation of cavity 26, method 20 applies an adhesive binding 28 to blank 10. For example, binding 28 can be applied to first face 16 in the cavity after blank 10 has been folded. Alternately, binding 28 can be inserted into cavity 26 as the cavity is formed.

In addition, binding 28 can exhibit elastic properties. Thus upon completion of method 20, binding 28 can secure trim 22 in the selected position and can aid in providing elasticity to blank 10.

Method 20 includes temporarily securing trim 22 in place using a temporary seam 30. Seam 30 can aid in securing binding 28 in cavity 26. Seam 30 can also aid in maintaining edge 12 in the selected position with respect to first face 16.

Seam 30, similar to the application of binding 28 discussed above, can be incorporated into blank 10 substantially simultaneous to the folding of the blank. Accordingly, a first step of method 20 provides for the substantially simultaneous folding to form trim 22, application of binding 28, and sewing to form seam 30.

However, seam 30 is a temporary seam. Specifically, seam 30 is formed with a yarn (not shown) that dissipates upon further processing. For example, seam 30 can be a heat labile seam that dissipates upon application of heat. As used herein, the term “dissipate” means that the seam substantially disappears both visually and tactilely.

In an exemplary embodiment, binding 28 can be a heat-activated adhesive binding that is activated at a first level of heat exposure. During exposure of heat to binding 28, trim 22 is maintained under a selected compression to ensure that binding 28 is firmly secured in cavity 26. Thus, binding 28 bonds first side 16 to itself to maintain edge 12 in the selected position, which forms curved edge 24 on blank 10.

In this same embodiment, seam 30 can be formed from a heat labile yarn that dissipates at a second level of heat exposure. Advantageously, the second level of heat exposure is less than the first level of heat exposure. Thus, the activation of binding 28 and the dissipation of seam 30 can occur at the same time, namely within the first level of heat exposure that is required to activate the binding. In this manner, method 20 not only provides the selected seamless trim 22, but can also provide the seamless trim in a minimal amount of time.

For example, binding 28 can be an EB 3106 adhesive commercially available from Bemis. Further, seam 30 can be formed with a Thermolux yarn that is commercially available from Luxilon Industries of Belgium. In this example, binding 28 is activated at a level of heat exposure of about 160 degrees Celsius to about 190 degrees Celsius for about 19 seconds. However, seam 30 dissipates at a level of heat exposure of about 15 seconds at about 140 degrees Celsius.

Thus, method 20 provides a simple, two step operation to form seamless trim 22 on blank 10. During the first step, edges 12 of blank 10 are folded, binding 28 is applied, and temporary seam 30 is sewn. During the second step, binding 28 is activated and seam 30 is dissipated.

In an alternate embodiment, seam 30 is formed from a soluble yarn that dissipates upon exposure to a selected solvent, such as water. Thus, seam 30 dissipates during further common solvent containing processes that blank 10 is exposed to instead of during the activation of binding 28. For example, seam 30 can be dissipated by one or more solvents associated with any conventional dyeing process used to color blank 10.

Seam 30 can instead be dissipated by the steam and/or heat associated with any conventional heat setting process used to shape blank 10. Further, seam 30 can instead be dissipated by water associated with any common washing process used to clean blank 10.

Advantageously, method 20 provides for trim 22 to be of a higher quality control than would be expected if the method did not include seam 30. Namely, seam 30 maintains trim 22 in the selected position until binding 28 has been activated. Thus, blanks 10 can be quickly bulk manufactured with trim 22 in substantially the same location from blank to blank.

Further, method 20 does not slow the manufacture of blank 10 into a garment. Specifically, it has been determined that seam 30 can be applied and removed within the time frame of one or more of the further processing steps that are common in the manufacture of blank 10.

Blank 10 is illustrated for use with a panty by way of example. It is contemplated by the present invention for blank 10 to find use with other garments. It should be recognized that blank 10 is illustrated as a tubular blank. Such tubular blanks 10 can be formed using circular knitting machines that are commercially available from, for example, Santoni of Italy. Of course, blank 10 can be formed by other methods such as traditional cut-and-sew methods.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the disclosure without departing from the scope thereof. Therefore, it is intended that the present invention not be limited to the particular embodiment(s) disclosed as the best mode contemplated for carrying out this invention, but that the invention will include all embodiments falling within the scope of the appended claims.

What is claimed is:

1. A method of forming a garment trim comprising:
folding a peripheral edge of a fabric to a selected position to form a cavity;
inserting a binding in said cavity;
securing said binding in said cavity and said peripheral edge in said selected position with a seam; and
exposing said fabric to at least one condition sufficient to cause said binding to bond to said cavity and said seam to dissipate.

2. The method of claim 1, wherein said seam is formed of a heat labile yarn.

3. The method of claim 2, wherein said at least one condition is a first heat level sufficient to cause said binding to bond to said cavity and said seam to dissipate.

4. The method of claim 1, wherein said seam is formed of a soluble yarn.

5. The method of claim 4, wherein said at least one condition is a first condition and a second condition.

6. The method of claim 5, wherein said first condition is a first heat level sufficient to cause said binding to bond to said cavity

7. The method of claim 5, wherein said second condition being a solvent exposure condition sufficient to cause said seam to dissipate.

8. The method of claim 1, wherein said binding has elastic properties.

9. The method of claim 1, wherein said fabric has a first side and a second side, and wherein said peripheral edge is folded towards said first side so that said cavity is formed between portions of said first side.

10. A method of forming a trim in a fabric, comprising:
folding a peripheral edge of said fabric to a selected position, said selected position being a fold over a binding;
maintaining said peripheral edge in said selected position with a seam;
applying heat and pressure to said peripheral edge to cause said binding to maintain said peripheral edge in said selected position; and
applying a selected process condition to said peripheral edge to cause said seam to dissipate.

11. The method of claim 10, wherein said selected process condition is applied to said peripheral edge substantially simultaneous to said applying heat and pressure to said peripheral edge.

12. The method of claim 10, wherein said selected process condition is applied to said peripheral edge subsequent to said applying heat and pressure to said peripheral edge.

13. The method of claim 10, wherein said seam is formed of a heat labile yarn.

14. The method of claim 13, wherein said selected process condition comprises said applying heat and pressure to said peripheral edge.

15. The method of claim 10, wherein said seam is formed of a soluble yarn.

16. The method of claim 15, wherein said selected process condition comprises applying a solvent to said peripheral edge sufficient to cause said seam to dissipate.

17. The method of claim 10, wherein said binding has elastic properties.

18. A method of forming a fabric having an elastic seamless trim comprising:
applying a binding to a first side of said fabric at a peripheral edge of said fabric, said binding having heat activatable adhesive properties and elastic properties;
folding said peripheral edge over said binding to form a curved edge;
sewing said peripheral edge and said binding with a seam, said seam having heat dissipatable properties; and
activating said heat activatable adhesive properties of said binding and said heat dissipatable properties of said seam to bond said binding to said fabric and to dissipate said seam.

19. The method as in claim 18, wherein said seam dissipates in less time than is needed to activate said binding.

20. The method as in claim 18, wherein said binding is applied substantially simultaneously to said folding of said peripheral edge and said sewing of said seam.

21. A method of forming a fabric having an elastic seamless trim comprising:
applying a binding to a first side of said fabric at a peripheral edge of said fabric, said binding having heat activatable adhesive properties and elastic properties;
folding said peripheral edge over said binding to form a curved edge;
sewing said peripheral edge and said binding with a seam, said seam having solvent dissipatable properties;
activating said heat activatable adhesive properties of said binding to bond said binding to said fabric; and
activating said solvent dissipatable properties of said seam to dissipate said seam.

22. The method as in claim 21, wherein said binding is applied substantially simultaneously to said folding of said peripheral edge and said sewing of said seam.
